(19) United States
(12) Patent Application Publication
(10) Pub. No.: US 2014/0201049 A1
(43) Pub. Date: Jul. 17, 2014

(54) EDGE DETERMINATION DEVICE

(71) Applicants: Freddy Guime, Aurora, IL (US); Victor Glava, Chicago, IL (US); Robert Kallay, Chesterton, IN (US)

(72) Inventors: Freddy Guime, Aurora, IL (US); Victor Glava, Chicago, IL (US); Robert Kallay, Chesterton, IN (US)

(73) Assignee: OptionsCity Software, Inc., Chicago, IL (US)

(21) Appl. No.: 13/739,531

(22) Filed: Jan. 11, 2013

(51) Int. Cl. G06Q 40/04

(52) U.S. Cl. CPC G06Q 40/04
USPC 705/37

(57) ABSTRACT

A method of determining an edge on an option strategy is disclosed. An option strategy may be accepted where the option strategy is a combination of buying and selling puts in calls. The edge for the options strategy may be determined by adding the delta edge to the vega edge.

### BACKGROUND

Trading exchanges historically provided a location for buyers and sellers to meet to trade stocks, bonds, currencies, commodities, and other items. The New York Stock Exchange and the Chicago Mercantile Exchange are examples of such trading exchanges. Recent advances in computer and communications technology have led to electronic trading exchange system networks. Electronic trading exchange system networks use communications networks and computers to replicate traditional face-to-face exchange functions. For example, centralized exchange computers disseminate market information, maintain records and statistics, settle cash payments, determine risk based margin requirements, and match trades. Matching of trades is typically done on a first come-first served basis, whereby time of order entry is an important criterion for determining priority in fulfillment of a transaction.

A communications network connects the exchange computers to numerous trader sites. Each trader site includes one or more trader stations operated by traders. Exchange network operators typically provide exchange members with interface software and, in some cases, hardware to enable traders to view prices and other information relating to products, and to execute transactions by submitting orders and quotes. This trading information is displayed in a grid or other organized format. Market competition is fierce. Traders who can quickly identify opportunities and act on them generate the largest profits.

Most trader stations in use today rely upon the traders themselves to decide whether to submit an order in response to a trading opportunity presented through the exchange. In this regard, the trading information is received from the exchange, processed, and displayed on a monitor of the trader's station. The trader reads the trading information from the monitor and decides whether or not to submit an order. The trader submits an order by entering instructions into the trader station using a keyboard or mouse.

Attempts have been made to implement trading systems that automate decision-making so that orders may be submitted with limited trader interaction. These systems have a number of drawbacks. For example, user-friendly systems that automatically submit orders without trader interaction, while faster than a human trader, are relatively slow in terms of computer speed due to application and system design. In a typical set-up, trading information received from the exchange is processed by general purpose backend computer equipment. The backend computer may, among other things, (1) act as a gateway by communicating to market information from the exchange to various types of client equipment, (2) submit, delete, and modify orders and quotes to the exchange from the various client equipment, (3) receive real-time trade confirmations and end-of-day back office reports, and (4) perform risk analysis, position management, and accounting functions. The trader stations are clients of the backend computer. The trader stations may be tasked with numerous functions, such as (1) receiving and displaying real-time market information, (2) creating and displaying theoretical prices related to market products, (3) composing, submitting, modifying, and deleting orders and quotes, (4) maintaining positions and calculating risk management, to name a few. Each trader station is typically configured in a very user-friendly, Windows-based environment since the trader will spend long periods of time each day watching and interacting with it. The overhead associated with the functions performed by the backend computer and the trader stations reduces the response speed of automated trading.

In addition, computer equipment lacks the trading judgment of a human trader. A computer can generate staggering losses in the blink of an eye by submitting orders based upon incomplete or mistaken assumptions inherent in the trading program, erroneous input data, or corrupted data relied upon by the trading program. Accordingly, there exists a need in the art for an automated trading system that rapidly responds to trade information transmitted from an exchange, yet is safe and accurate. For example, automated hedging may be used to hedge the vega risk, the risk of a position or trade due to price changes of the options arising from changes of an option's volatility.

### SUMMARY

A method of determining an edge on an option strategy is disclosed. An option strategy may be accepted where the option strategy is a combination of buying and selling puts in calls. A time edge is determined based on the option strategy. A delta value is determined where the delta value reflects acceptance of risk related to an underlying security in the option strategy. A vega value is determined where the vega value reflects acceptance of risk related to volatility of the underlying security in the option strategy. A delta percentage may be accepted to be applied to delta risk. A vega percentage may be accepted to be applied to vega risk. The delta percentage and the vega percentage may add up to 1. The delta edge may be determined by multiplying the time edge by the delta percentage multiplied by the delta value. Similarly, a vega edge may be determined by multiplying the time edge by the vega percentage multiplied by the vega value. The edge for the options strategy may be determined by adding the delta edge to the vega edge.

### BRIEF DESCRIPTION OF THE DRAWINGS

FIG. 1 is an illustration of a mobile computing device, a server type computer device and a communication device;

FIG. 2 is an illustration of a portable computing device;

FIG. 3 is an illustration of a server type computing device;

FIG. 4 is an illustration of a method determining an edge on an option strategy;

FIG. 5 is an illustration of setting the time edge;

FIG. 6 is an illustration of setting the delta value;

FIG. 7 is an illustration of setting the vega value;

FIG. 8 is an illustration of adjusting the edge tilt between vega and delta; and

FIG. 9 may illustrate an example of a spread (the one that is checked) that may be sent into the exchange for a quote request.

### DESCRIPTION

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

Options are derivative securities whose values are a function of an underlying asset.

The price of an underlying asset for immediate purchase is called the spot price. A vanilla option on an (underlying) asset gives the buyer the right, but not the obligation, to buy (Call) or sell (Put) the underlying asset at the strike price. Where options are traded the price-maker prepares a bid price and an offer price. The bid price is the price at which the trader is willing to purchase the option and the offer price is the price at which the trader is willing to sell the option. The difference between the bid and offer prices is referred to as the bid-offer spread.

In the early 1970s Black and Scholes, and Merton, independently developed an option pricing model that is still in use today. The BSM model, as it is commonly known, provides unique closed form solutions for the price of European vanilla options. BSM found that by constructing and dynamically maintaining an option replication portfolio consisting of assets whose prices are known, they could obtain a precise option price by exploiting the no-arbitrage condition. Of course, other option pricing models exist and might be used as well.

The BSM model is limited in that it only values the convexity of the option delta with respect to the underlying asset price. Other crucial convexities in the real world are not priced by BSM models, such as vega and delta convexities to implied volatility. While attempts have been made to derive a model which endogenously values all key convexities, price-makers prefer the pragmatic approach of adjusting the BSM implied volatility to make the model work in practice. These adjustments are called smile and skew and are defined by vega neutral butterflies and risk reversals respectively.

A vega neutral butterfly is a trading strategy in which a strangle is purchased and a zero-delta straddle is sold, both with the same maturity date, such that the vega of the strategy starts at zero. A strangle is a trading strategy requiring the simultaneous purchase (or sale) of a Put option and a Call option, with identical face values and maturity dates but different strike prices, such that the delta of the strategy is equal to zero. A zero-delta straddle is a trading strategy requiring the simultaneous purchase (or sale) of a Put option and a Call option, with identical face values, maturity dates and strike prices, such that the delta of the strategy is equal to zero. A risk reversal is a trading strategy in which a Call (Put) option is purchased and a Put (Call) option is sold, where both have identical deltas, maturity date and face value.

The BSM methodology has been applied to exotic as well as vanilla payoffs, to obtain the theoretical value of exotic options. For example, American binary options are amongst the most heavily traded exotic foreign exchange (FX) options. Option risks are described by a set of partial derivatives commonly referred to as “the Greeks”. Option Greeks include:

Delta: the amount that an option price will change given a small change in the price of the underlying asset. In other words it is the partial derivative of the option price which respect to the spot asset price; and

Vega: the amount that an option price will change given a small change in volatility. In other words it is the partial derivative of the option price with respect to volatility.

There are other Option Greeks which may be displayed, either alone or in combination with delta and vega, along with a variety of market conditions or positions.

### Computer System

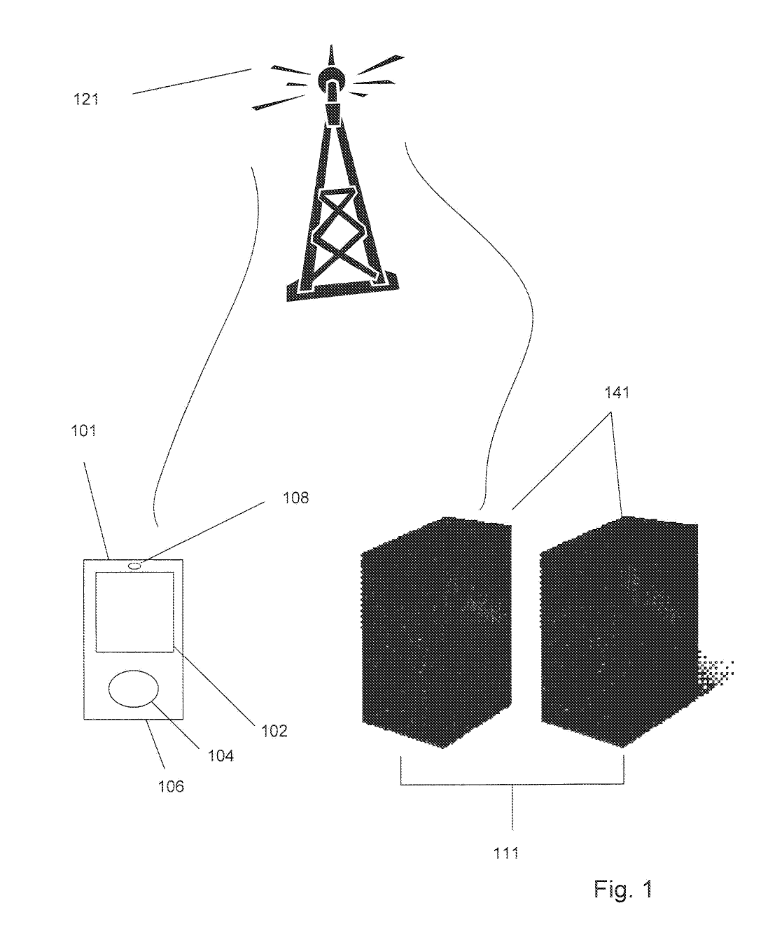

FIG. 1 may be a high level illustration of some of the elements a sample computing system. The computing system may be a dedicated computing device 141, a dedicated portable computing device 101, an application on the computing device 141, an application on the portable computing device 101 or a combination of all of these. FIG. 1 may be a high level illustration of a portable computing device 101 communicating with a remote computing device 141 but the application may be stored and accessed in a variety of ways. In addition, the application may be obtained in a variety of ways such as from an app store, from a web site, from a store Wi-Fi system, etc. There may be various versions of the application to take advantage of the benefits of different computing devices, different languages and different API platforms.

In one embodiment, a portable computing device 101 may be a device that operates using a portable power source 155 such as a battery. The portable computing device 101 may also have a display 102 which may or may not be a touch sensitive display. More specifically, the display 102 may have a capacitance sensor, for example, that may be used to provide input data to the portable computing device 101. In other embodiments, an input pad 104 such as arrows, scroll wheels, keyboards, etc., may be used to provide inputs to the portable computing device 101. In addition, the portable computing device 101 may have a microphone 106 which may accept and store verbal data, a camera 108 to accept images and a speaker 110 to communicate sounds.

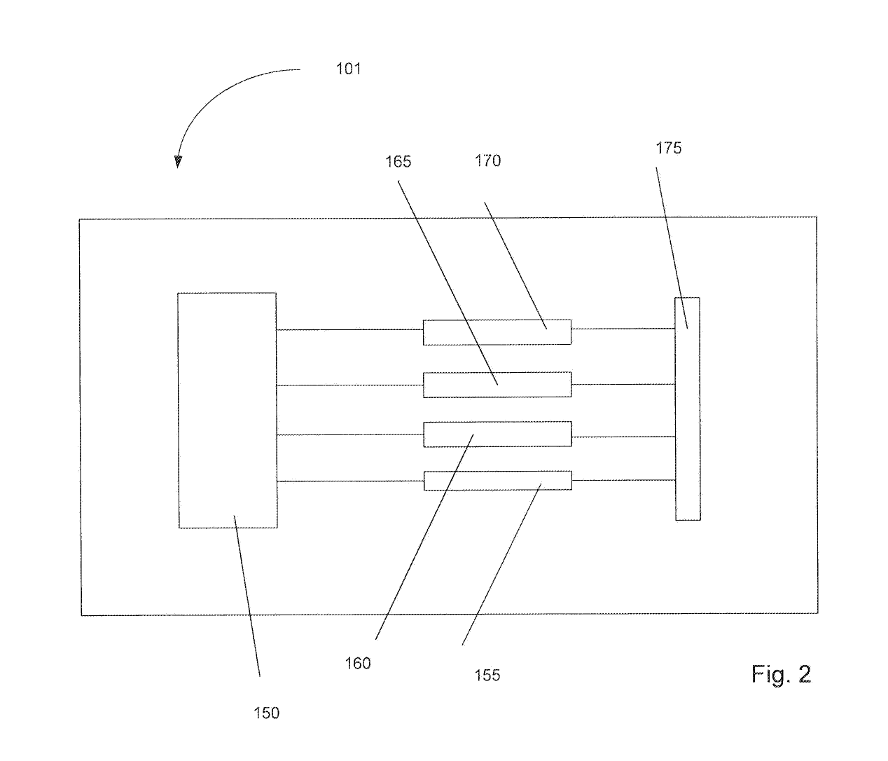

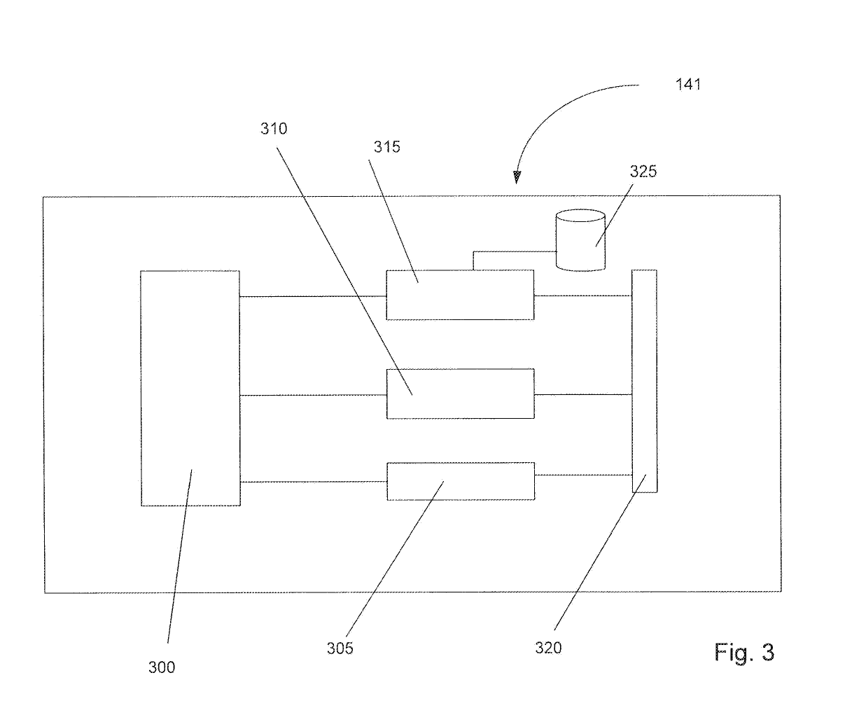

The portable computing device 101 may be able to communicate with a computing device 141 or a plurality of computing devices 141 that make up a cloud of computing devices 111. The portable computing device 101 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the computing device 141 or may he through a communication network 121 such as cellular service, through the Internet, through a private network, through Bluetooth, etc. FIG. 2 may be a simplified illustration of the physical elements that make up a portable computing device 101 and FIG. 3 may be a simplified illustration of the physical elements that make up a server type computing device 141.

FIG. 2 may be a sample portable computing device 101 that is physically configured according to be part of the system. The portable computing device 101 may have a processor 150 that is physically configured according to computer executable instructions. It may have a portable power supply 155 such as a battery which may be rechargeable. It may also have a sound and video module 160 which assists in displaying video and sound and may turn off when not in use to conserve power and battery life. The portable computing device 101 may also have volatile memory 165 and non-volatile memory 170. There also may be an input/output bus 175 that shuttles data to and from the various user input devices such as the microphone 106, the camera 108 and other inputs 102, etc. It also may control of communicating with the networks, either through wireless or wired devices. Of course, this is just one embodiment of the portable computing device 101 and the number and types of portable computing devices 101 is limited only by the imagination. The portable computing device 101 may act as a dedicated device to implement the method or may be a part of a computing system.

The physical elements that make up the remote computing device 141 may be further illustrated in FIG. 3. At a high level, the computing device 141 may include a digital storage such as a magnetic disk, an optical disk, flash storage, non-volatile storage, etc. Structured data may be stored in the digital storage such as in a database. The computing device 141 may be a type of server and may have a processor 300 that is physically configured according to computer executable instructions. It may also have a sound and video module 305 which assists in displaying video and sound and may turn off when not in use to conserve power and battery life. The server 141 may also have volatile memory 310 and non-volatile memory 315.

The database 325 may be stored in the memory 310 or 315 or may be separate. The database 325 may also be part of a cloud 111 of computing device 141 and may be stored in a distributed manner across a plurality of computing devices 141. There also may be an input/output bus 320 that shuttles data to and from the various user input devices such as the microphone 106, the camera 108, the inputs 102, etc. The input/output bus 320 also may control of communicating with the networks, either through wireless or wired devices. In some embodiments, the application may be on the local portable computing device 101 and in other embodiments, the application may be remote 141. Of course, this is just one embodiment of the computing devices 141 and the number and types of portable computing devices 101 is limited only by the imagination.

### Edge Determination

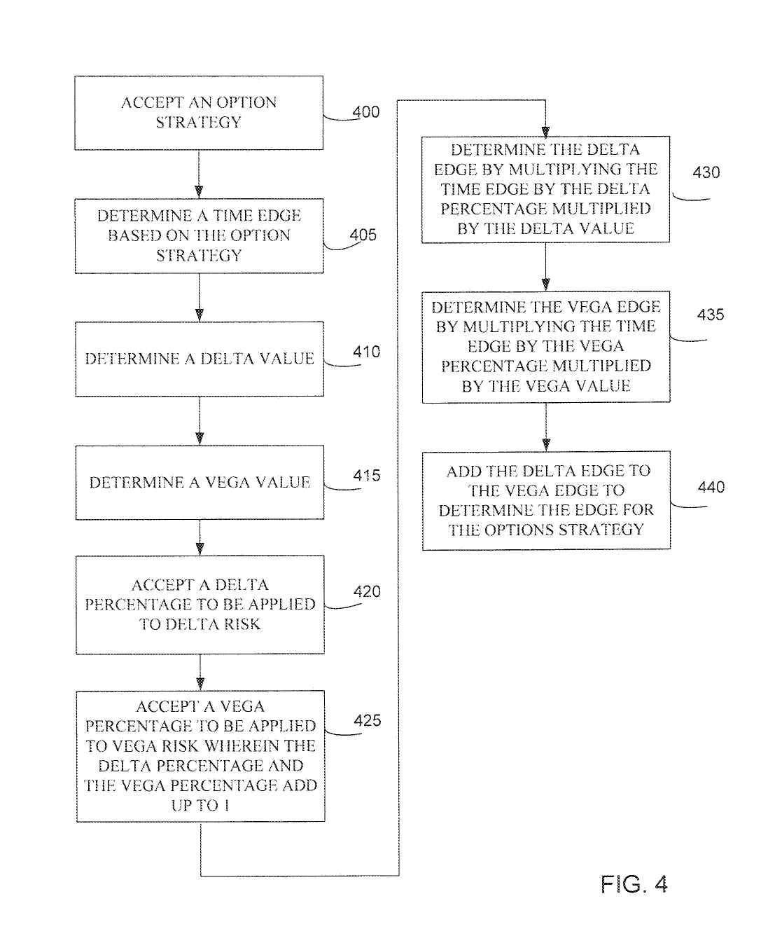

FIG. 4 may illustrate one method of determining an edge on an option strategy. An edge may be thought of as a premium over a calculated value, such as a theoretical value. Some users may view risk differently than other users and thus, the pricing of the edge may be different for each user. In the past, traders often went by feel or experience in pricing the edge on complex trades. The method may allow users to adjust edge pricing based on quantifiable factors to be specific to a user, a customer, an asset, an asset class or any other specific entity that is relevant to edge pricing. The result is that pricing of complex options including the edge may be completed faster than in the past. Further, by using quantifiable factors, the pricing may be totally automated, resulting in rapid and accurate complex option pricing with no human involvement.

The method may be physically embodied in a variety of ways. In some embodiments, a dedicated physical device such as a computer 141 may be purpose built to execute the method. It may be portable 101 or it may be a server based system 111. In other embodiments, it may be a combination of a portable computing device 101 and a server 141. In yet additional embodiments, it may be a storage device such as a CD, DVD, Blu-Ray, hard drive, solid state storage device or other storage device that are physically configured to store and allow execution of the various embodiments of the method. Of course, the manner of implementation may vary and the many different implementation methodologies are contemplated.

At block 400, an option strategy may be accepted. Option strategies are many and varied. By combining puts and calls along with buying and selling the puts and calls, many different risks may be addressed and many different payout scenarios can be created by an option strategy. Further, by varying the elements of the options such as the strike price, the expiration, etc., even more risk and payout profiles may be created. Common strategies are given names such as straddles, strangles, butterfly, etc.

At block 405, a time edge based on the option strategy may be determined. The time based edge may represent the concept that an option which expires further in the future may have more risk than an option that expires tomorrow. Logically, a higher risk would entail a higher edge requirement. Thus, options that expire further into the future usually have a higher edge requirement than options that expire sooner. Time edge may be thought of as a base edge which may be broken down between delta edge and vega edge as will be explained.

In additional embodiments, the time edge may be learned. Past trades may be reviewed to determine a time edge for a user, a customer, an asset, etc. The learning may take into account changes over time and more recent trades may be given a greater weight than trades in the distant past. Further, the result of trades in the past may be analyzed to determine if the time edge was appropriate considering how the trade resulted (gain/loss and magnitude) at the time of selling or at the time of expiration.

At block 410, a delta value may be determined. At a high level, the delta value may reflects acceptance of risk related to an underlying security in the option strategy. In one embodiment, the delta value is determined as a change in the value of the underlying strategy in view of the change in an underlying security. In addition, the delta edge may be user specific. Some users may be more tolerant of delta risk than others. For example, a user may have an offsetting position which may negate the delta risk of a trade. Thus, such a user may have a lower delta value than another. Further, the delta value may be customer specific, asset specific, group specific, etc.

In additional embodiments, the delta value may be learned. Past trades may be reviewed to determine a delta value for a user, a customer, an asset, etc. The learning may take into account changes over time and more recent trades may be given a greater weight than trades in the distant past. Further, the result of trades in the past may be analyzed to determine if the delta value was appropriate considering how the trade resulted (gain/loss and magnitude) at the time of selling or at the time of expiration.

At block 415, a vega value may be determined. The vega value may reflect an acceptance of risk related to volatility of the underlying security in the option strategy. In other words, vega may give the user an indication of how much the value of a strategy will change relative to an at the money option in the farthest month of the strategy when the implied volatility of the underlying asset changes. Logically, the vega edge may be user specific, asset specific, customer specific, etc.

In some embodiments, the vega value may be a normalized vega value. For example, the vega value may be determined as a vega value for an instrument at the money with the most time to expiration relative to the other instruments in the strategy in comparison to a vega value for any instrument. As the vega is measured for a unit of option strategy, it is not a dollar strategy, but a unit of the option strategy. For example, a vega (or option equivalent vega) of 1.5 may mean buying or selling 1.5 at the money options in the farthest month to flatten out the vega risk of the strategy if the user purchased 1 lot of the strategy.

In additional embodiments, the vega value may be learned. Past trades may be reviewed to determine a vega value for a user, a customer, an asset, etc. The learning may take into account changes over time and more recent trades may be given a greater weight than trades in the distant past. Further, the result of trades in the past may be analyzed to determine if the vega value was appropriate considering how the trade resulted (gain/loss and magnitude) at the time of selling or at the time of expiration.

At block 420, a delta percentage may be accepted to be applied to delta risk and at block 425, a vega percentage to be applied to vega risk may be accepted where the delta percentage and the vega percentage add up to 1. In use, the delta percentage and vega percentage may be used to adjust the edge in a way that suits a user, a customer, an asset, or other group.

At block 430, the delta edge may be determined by multiplying the time edge by the delta percentage multiplied by the delta value. The time edge may be broken down between the delta edge and the vega edge. Similarly, at block 435, the vega edge may be determined by multiplying the time edge by the vega percentage multiplied by the vega value. At block 440, the delta edge may be added to the vega edge to determine the edge for the options strategy.

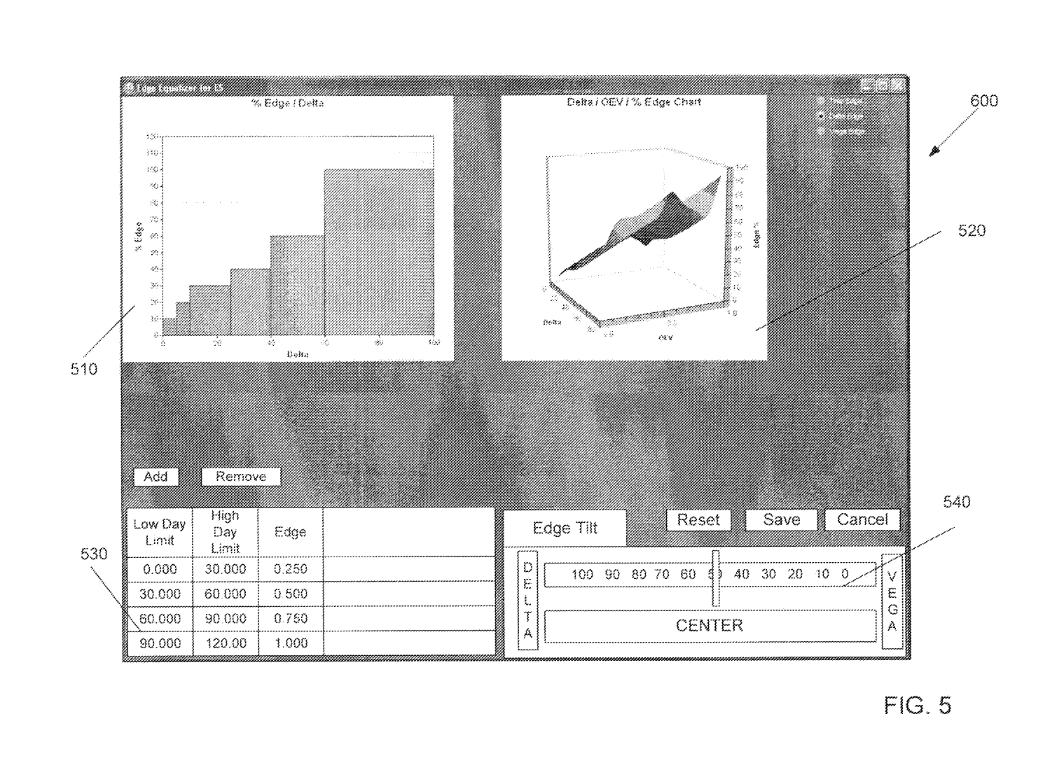

FIG. 5 is an illustration 500 of setting the time edge. A separate illustration may graph edge against time 510. An addition illustration may be a three dimensional graph of delta, vega and the percentage edge 520. A chart 530 may also list the edge for various limits. The chart 530 may be adjustable by a user. In addition, the edge may be adjusted between delta and vega using a slide adjustment 540 on a 0-100 scale.

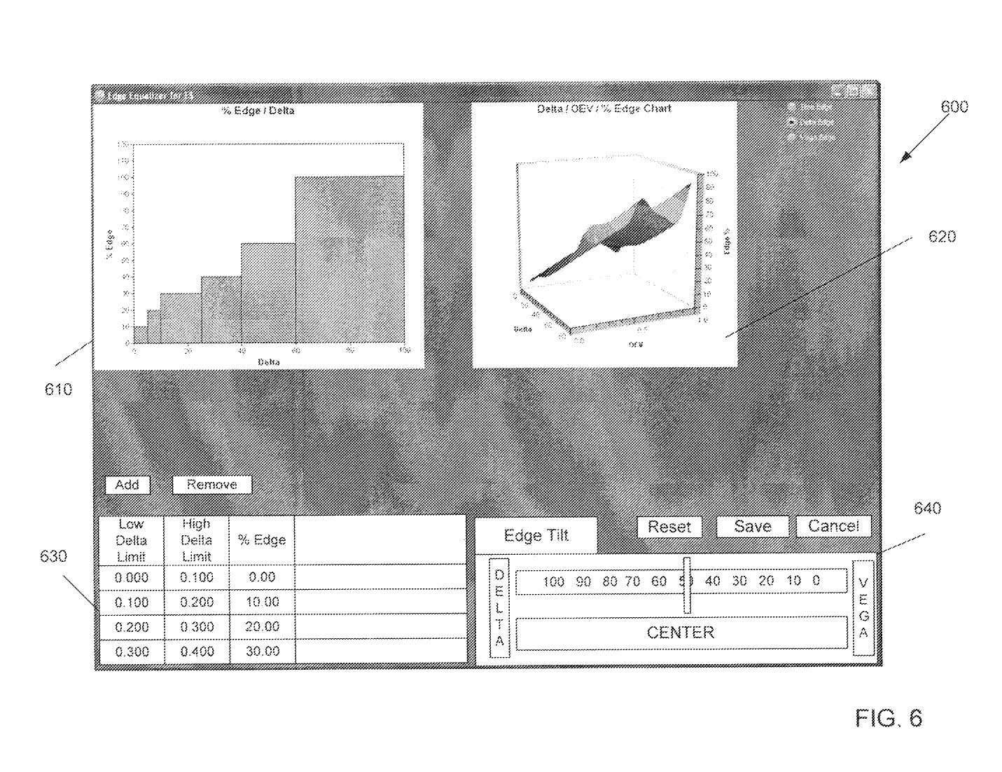

FIG. 6 is an illustration 600 of setting the delta value. A separate illustration may graph edge percentage against delta 610. An addition illustration may be a three dimensional graph of delta, vega and the percentage edge 620. A chart 630 may also list the percentage edge for various delta limits. The chart 630 may be adjustable by a user. In addition, the edge may be adjusted between delta and vega using a slide adjustment 640 on a 0-100 scale.

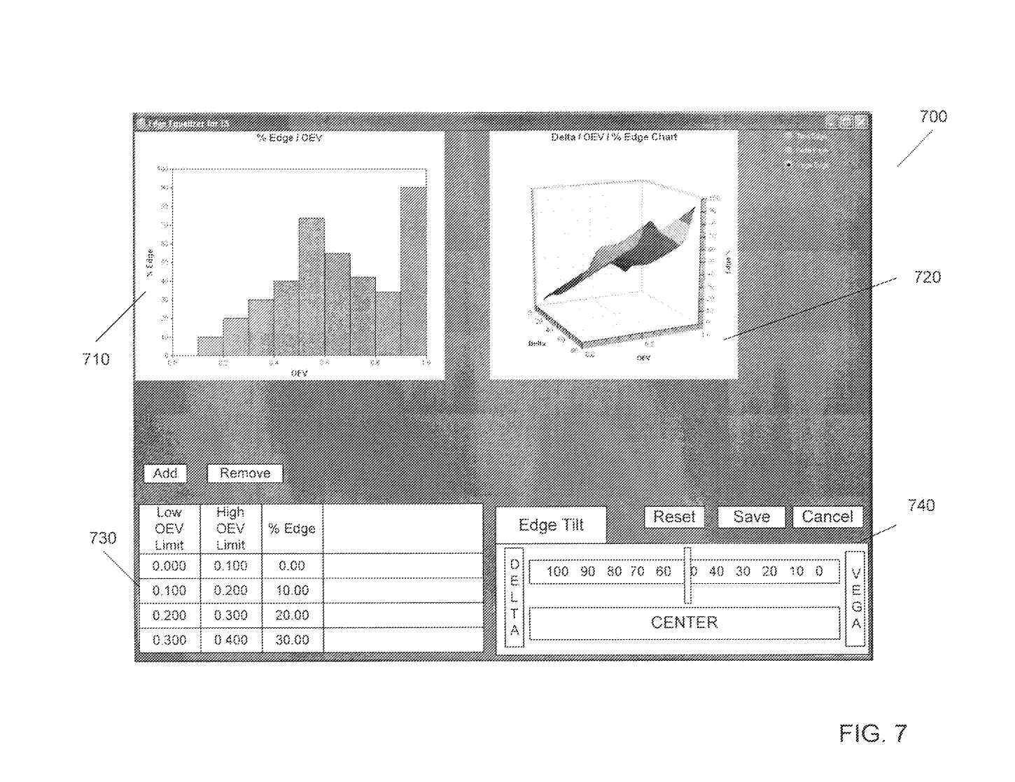

FIG. 7 is an illustration 700 of setting the vega value. A separate illustration may graph edge percentage against vega 710. An addition illustration may be a three dimensional graph of delta, vega and the percentage edge 720. A chart 730 may also list the percentage edge for various vega limits. The chart 730 may be adjustable by a user. In addition, the edge may be adjusted between delta and vega using a slide adjustment 740 on a 0-100 scale.

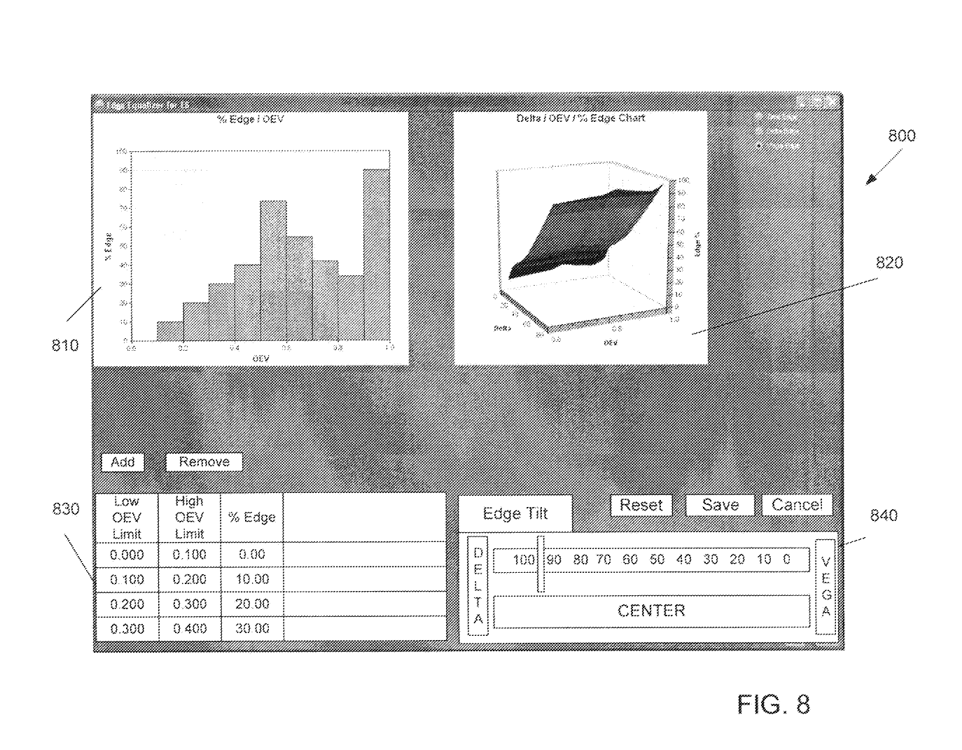

FIG. 8 is an illustration 800 of adjusting the edge tilt 840 between vega and delta. While FIG. 7 illustrates a 50-50 balance between delta and vega, FIG. 8 illustrates tilt of 91% delta and 9% vega in the slider 840. The changes in the edge percentage against vega 810, the changes in the three dimension graph of delta, vega and the percentage edge 820 and the chart 830 may be observed.

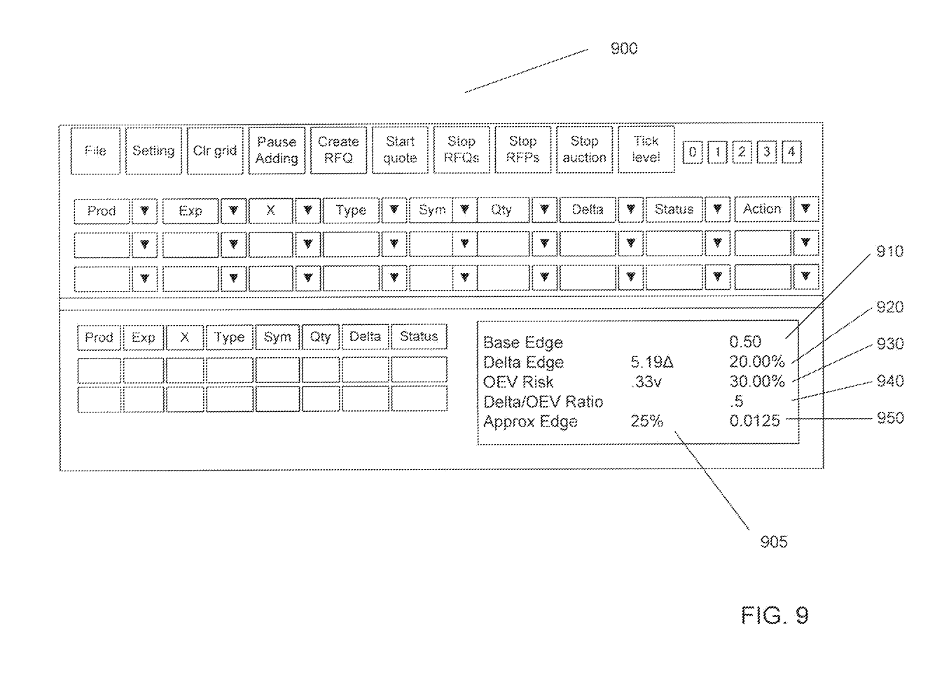

FIG. 9 may illustrate 900 an example of a spread (the one that is checked) that may be sent into the exchange for a quote request. In a separate display area 905, the method broke down this spread according to Time (base edge) 910, Delta 920, Vega (Oev) 930 and Ratio (edge tilt) 940 to solve for the appropriate amount of edge 950 for the spread=0.125 given the users inputs.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

1. A computerized method of determining an edge on an option strategy comprising:
receiving an option strategy for processing by a processor, said option strategy including at least the following data stored in a memory: data for an underlying asset in the option strategy, user data, customer data, asset data, and time parameter associated with a trade of the underlying asset in the option strategy is transacted;
determining, by the processor, a time edge based on the option strategy, said time edge being an estimated premium value, over a calculated value, as a function of time for the option strategy;
determining, by the processor, a delta value wherein the delta value reflects acceptance of risk related to an underlying security in the option strategy;
determining, by the processor, a vega value wherein the vega value reflects acceptance of risk related to volatility of the underlying security in the option strategy;
accepting a delta percentage to be applied to delta risk;
accepting a vega percentage to be applied to vega risk wherein the delta percentage and the vega percentage add up to 1;
determining, by the processor, a delta edge comprising multiplying the time edge by the delta percentage multiplied by the delta value;
determining, by the processor, a vega edge comprising multiplying the time edge by the vega percentage multiplied by the vega value; and
determining, by the processor, the edge for the options strategy based on a sum of the delta edge to the vega edge.

2. The method of claim 1, further comprising receiving from a user for setting at least one of the delta percentage and the vega percentage.

3. The method of claim 1, wherein the delta value is determined as a change in the value of the option strategy in view of the change in an underlying security.

4. The method of claim 1, wherein determining the vega value comprises determining a normalized vega value.

5. The method of claim 1, wherein determining the vega value comprises determining a vega value for an instrument at the money with the most time to expiration relative to other instruments in the option strategy in comparison to a vega value for any instrument.

6. The method of claim 1, wherein determining the vega value comprises determining a vega value for an instrument at the money in comparison to a vega value for an instrument not at the money.

7. The method of claim 5, wherein determining the vega value determining the vega value as a change in value of the option strategy in face of a change in volatility of the underlying asset when the option strategy is at the money in comparison to the change in a value of the option strategy in face of a change in volatility of the underlying asset when the option strategy is not in the money.

8. The method of claim 1, wherein determining the delta edge comprises determining the delta edge wherein the delta edge is user specific.

9. The method of claim 1, wherein determining the vega edge comprises determining the delta edge wherein the vega edge is user specific.

10. A computer system comprising:
a processor physically configured according to computer executable instructions,
a memory physically configured for storing computer executable instructions and an input/output circuit, said memory being accessible by the processor, the processor configured for executing the computer executable instructions, the computer executable instructions comprising instructions for determining and presenting an edge on an option strategy, the instructions comprising instructions for:
receiving an option strategy, wherein the memory stores at least the following data associated with the option strategy: data for an underlying asset in the option strategy, user data, customer data, asset data, and time parameter associated with a trade of the underlying asset in the option strategy is transacted;
determining a time edge based on the option strategy, said time edge being an estimated premium value, over a calculated value, as a function of time for the option strategy;
determining a delta value wherein the delta value reflects acceptance of risk related to an underlying security in the option strategy;
determining a vega value wherein the vega value reflects acceptance of risk related to volatility of the underlying security in the option strategy;
accepting a delta percentage to be applied to delta risk;
accepting a vega percentage to be applied to vega risk wherein the delta percentage and the vega percentage add up to 1;
determining a delta edge comprising multiplying the time edge by the delta percentage multiplied by the delta value;
determining a vega edge comprising multiplying the time edge by the vega percentage multiplied by the vega value; and
determining the edge for the options strategy based on the sum of the delta edge to the vega edge.

11. The computer system of claim 10, wherein the processor is further configured to execute computer executable instructions for receiving inputs from a user to set at least one of the delta percentage and the vega percentage.

12. The computer system of claim 10, wherein the processor is further configured to execute computer executable instructions for determining the delta value wherein the delta value is determined as a change in the value of the option strategy in view of the change in an underlying security.

13. The computer system of claim 10, wherein the processor is further configured to execute computer executable instructions for determining the vega value wherein the vega value is a normalized vega value.

14. The computer system of claim 10, wherein the processor is further configured to execute computer executable instructions for determining the vega value wherein the vega value is determined as a vega value for an instrument at the money with the most time to expiration relative to other instruments in the option strategy in comparison to a vega value for any instrument.

15. The computer system of claim 10, wherein the processor is further configured to execute computer executable instructions for determining the vega value wherein the vega value is determined as a vega value for an instrument at the money in comparison to a vega value for an instrument not at the money.

16. The computer system of claim 15, wherein the processor is further configured to execute computer executable instructions for determining the vega value wherein the vega value is determined as a change in value of the option strategy in face of a change in volatility of the underlying asset when the option strategy is at the money in comparison to the change in a value of the underlying strategy in face of a change in volatility of the underlying asset when the option strategy is not in the money.

17. The computer system of claim 10, wherein the delta edge is user specific.

18. The computer system of claim 10, wherein the vega edge is user specific.
